(19) United States
(12) Patent Application Publication
(10) Pub. No.: US 2024/0329673 A1
(43) Pub. Date: Oct. 3, 2024

(54) SYSTEM AND METHOD FOR CONTROLLING VACUUM IN A CLOSED FLUID SYSTEM

(71) Applicants: PLACEMENTS CHIC INC., Sherbrooke (CA); GESTION JOSERA INC., Stornoway (CA)

(72) Inventor: Martin Chicoine, Sherbrooke, QC (CA)

(21) Appl. No.: 18/577,025

(22) PCT Filed: Jul. 6, 2021
(86) PCT No.: PCT/CA2021/050918

§ 371 Date: Jan. 5, 2024

(51) Int. Cl. G05D 16/20; A01J 5/01; A01J 7/00

(52) U.S. Cl. CPC G05D 16/202; A01J 5/01; A01J 7/00

(57) ABSTRACT

A vacuum controller for isolating the vacuum chamber of a vacuum pump, the vacuum controller comprising a shell comprising an inlet and an outlet, the outlet being fluidly connected to the vacuum pump, a diaphragm disposed within the shell and defining a first cavity and a second cavity within the shell, the first and second cavities being on opposite sides of the diaphragm and the second cavity being in fluid communication with the outlet, a pressure balance module adapted to selectively fluidly connect the first and second cavities in an open configuration and a controller adapted to selectively actuate the pressure balance module wherein the diaphragm fluidly restricts at least one of the inlet and the outlet when the pressure balance module is in a closed configuration.

### CROSS-REFERENCE TO RELATED APPLICATIONS

There are no cross-related applications.

### FIELD OF THE INVENTION

The present invention generally relates to systems and methods managing vacuum in closed fluid systems such as pipes and/or tubes. More particularly, the present invention relates to systems and methods to vary vacuum level in tubing systems.

### BACKGROUND OF THE INVENTION

Some traditional maple tubing systems use vacuum pump to lower pressure in the tubing system. The lowered or negative pressure within the tubing system generally ensures that the healing of the notch or cut in the tree is retarded as less oxygen is present in the system and/or generate an artificial weather environment increasing sap production of the maple trees. Furthermore, as less oxygen is present, the oxygen-less environment refrain bacteria from proliferating to maintain a sanitary environment. Such systems typically use large industrial pumps to create the negative pressure in the tubing system. The sap generally flows as tubes are angled toward the reservoir or tank. The pumps are typically adapted to create a low-pressure environment within one or more main lines and lateral lines of the maple tubing systems which can regularly span several kilometers. As to the network of tubing is vast, the vacuum pump must operate for a substantial period of time to adjust pressure, such as lower or raise, in the tubing system.

The sap flow of a maple tree is moreover heavily weather-dependent, with temperature fluctuations creating pressure within the tree to move the sap. Specifically, ambient temperatures must fall below freezing (usually at night) and rise above freezing (usually during the day), for sap to flow. During a freezing event, low-pressure at the surface of the tree trunk draws water up from the roots. When a warm day follows, higher pressure develops in the tree, forcing sap through the xylem and out the taphole or wound.

The negative pressure present in tubing by the use of a vacuum pump lowers the temperature of sap flowing in the tube. Thus, even if outside temperatures is above the freezing point, the temperature within the tubing may freeze the sap which limits or blocks the flow of sap from the tree to a reservoir. Nevertheless, many producers choose to leave their pumps on at all times as the time to establish the necessary low-pressure environment may take many hours. As such, the flow of sap is reduced during low temperature periods which decreases the efficiency of the flow of sap in the tubing. Indeed, due to the time delay required to achieve a suitable pressure, producers are often unable to suitably react to temperature fluctuations in order to maximise sap flow.

As a vacuum pump is very power intensive, the use of such vacuum systems may represent a high percentage of the electrical or power consumption of a maple syrup installation.

In other agricultural environments, such as animal husbandry or livestock farming, vacuum systems may be used in tubing system adapted to convey milk from animals to reservoirs or for cleaning/washing purposes. Again, the vacuum environment generally allows creating a sanitary environment. As explained above and similarly to maple syrup installations, the usage of vacuum systems is very power intensive.

There is therefore a need for an apparatus or method for easily controlling or adjusting a negative pressure within a tubing system and/or to substantially reduce the power consumption of the operations of a vacuum system.

### SUMMARY OF THE INVENTION

The aforesaid and other objectives of the present invention are realized by generally providing a system for controlling vacuum level in a closed fluid system.

The system comprises a valve and a controller. The valve comprises an inlet fluidly connectable with the closed system, an outlet in fluidly connectable to a vacuum pump and a pressure-controlled vacuum control device between the inlet and the outlet. The controller is in fluid communication with the pressure-controlled vacuum control device and is configured to measure the pressure in the valve and vary the pressure in the pressure-controlled vacuum control device based on the measured pressure in the valve, wherein a variation of pressure in the pressure-controlled vacuum control device impacts the vacuum level in the tubing system.

The pressure-controlled vacuum control device may comprise a flexible membrane forming a first sealed cavity on a first side of the membrane and a second sealed cavity on a second side of the membrane, the second sealed cavity being in fluid communication with the closed system.

The controller may be further configured to independently vary the pressure in the first sealed cavity and in the second sealed cavity. The increase of pressure in the first sealed cavity may reduce the vacuum level in the closed system and the decrease of pressure in the first sealed cavity may increase the vacuum level in the closed system. The pressure-controlled vacuum control device may further comprise a support for the flexible membrane, the support creating a passage between the inlet and the outlet, the opening of the passage being controlled by the flexible membrane. The valve may comprise a body and a bonnet, the support and the flexible membrane being between the body and the bonnet. The system may further comprise at least one fastener for securing the body, the flexible membrane, the support and the bonnet. The support may comprise at least one inlet aperture in fluid communication with the inlet and at least one outlet aperture in fluid communication with the outlet, the flexible membrane fluidly restricting one of the at least one aperture when the pressure in the first sealed cavity is higher than the pressure in the second sealed cavity.

The valve may further comprise a pressure balancing system in fluid communication with the first sealed cavity and the second sealed cavity. The pressure balancing module may comprise a first servo valve controlling the variation of pressure level in the first sealed cavity through input of a fluid in the first sealed cavity, the inputted fluid having a pressure level higher than the vacuum level in the closed system. The pressure balancing module may further comprise a second servo valve balancing the pressure level between the first sealed cavity and the second sealed cavity. The system may further comprise first and second sensors in communication with the controller, the first sensor being configured to measure the pressure level in the first sealed cavity and the second sensor being configure to measure the pressure level in the second cavity, the controller being configured to control the first and second servo valve to vary the pressure level in the first and second sealed cavities based on the pressure level measured by the first and second sensors.

The flexible membrane may be made with an elastomer. The system may comprise a pressure sensor measuring the pressure level in the valve. The sensor may be in communication with the controller. The sensor may fluidly connected to the valve.

The system may further comprise first and second sensors in communication with the controller, the first sensor being configured to measure the pressure level in the first sealed cavity and the second sensor being configure to measure the pressure level in the second cavity.

The closed fluid system may comprise gas, the gas may be air. The closed fluid system may convey sap from trees or milk from animals.

In another aspect of the invention, a method for controlling vacuum level in a closed fluid system is provided. The method comprises increasing the relative pressure in a first sealed cavity of a valve in relation to a second cavity to decrease the vacuum level of the closed system, the second sealed cavity being in fluid communication with the closed system and decreasing the relative pressure in the first sealed cavity in relation to the second sealed cavity to increase the vacuum level of the closed system.

The increase of the relative pressure in the first sealed cavity may comprise allowing a fluid in the first sealed cavity, the fluid having a pressure level higher than the pressure level in the closed system in the first sealed cavity. The fluid may be ambient air. Allowing the fluid may comprise actuating a servo motor fluidly connecting a source of the fluid and the first sealed cavity. The decrease of the relative pressure in the first sealed cavity may comprise balancing at least in part the pressure level between the first sealed cavity and the second sealed cavity. The balancing of the pressure level may comprise actuating a servo motor fluidly connecting the first and then second sealed cavities.

The method may further comprise measuring the vacuum level in the first sealed cavity. The method may further comprise measuring the vacuum level in the second sealed cavity. The method may further comprise a controller triggering the increase or the decrease of relative pressure based on the measured vacuum level in the first and second sealed cavities.

The closed fluid system comprising gas, the gas may be air. The closed fluid system may convey sap from trees or milk from animals.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is an illustration of a maple tubing system comprising a vacuum controller in accordance with the principles of the present invention.

FIG. 2 is an isometric view of an exemplary vacuum controller in accordance with the principles of the present invention.

FIG. 3 is an isometric exploded view of the vacuum controller of FIG. 1.

FIG. 4. is a front side elevation view of the vacuum controller of FIG. 1.

FIG. 5 is a back side elevation view of the vacuum controller of FIG. 1.

FIG. 6 is a left side elevation view of the vacuum controller of FIG. 1.

FIG. 7 is a right-side elevation view of the vacuum controller of FIG. 1.

FIG. 8 is an illustration of an embodiment of a controller of a system for controlling vacuum in a closed fluid system in accordance with the principles of the present invention.

FIG. 9 is an illustration of an embodiment of a controller of a system for controlling vacuum in a closed fluid system in accordance with the principles of the present invention shown connected to a vacuum valve.

### DETAILED DESCRIPTION OF THE PREFERRED EMBODIMENT

A novel system and method for controlling vacuum in a tubing system will be described hereinafter. Although the invention is described in terms of specific illustrative embodiments, it is to be understood that the embodiments described herein are by way of example only and that the scope of the invention is not intended to be limited thereby.

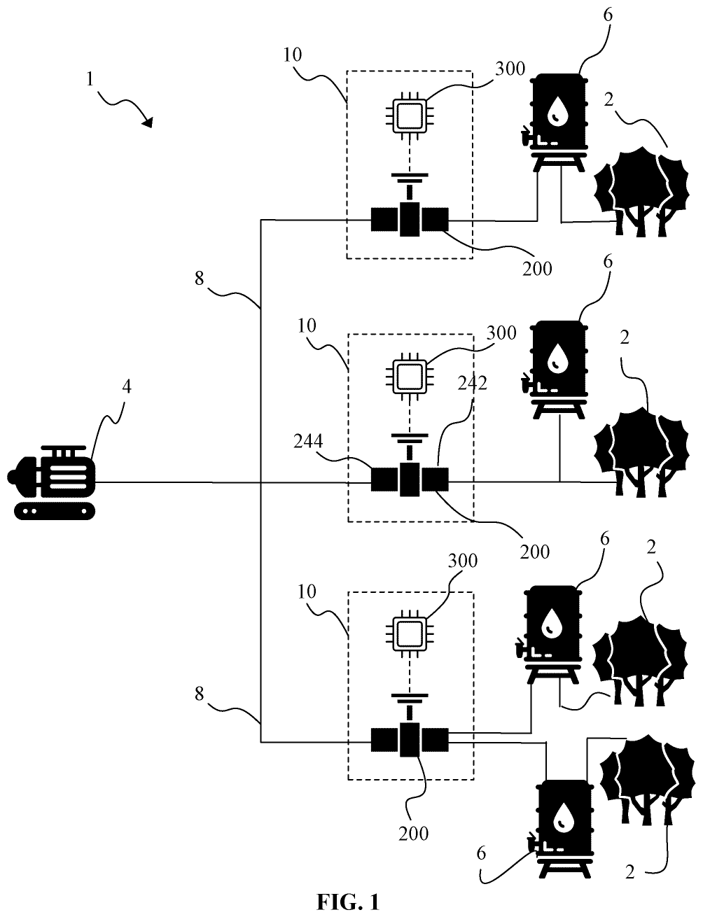

Referring to FIG. 1, an embodiment of a maple tubing system 1 for the collection of sap is illustrated. The maple tubing system 1 comprises one or more conduits 8 adapted to convey sap from one or more sap producing trees 2 to a reservoir 6. The sap may be conveyed within the conduits as the conduits are sloped or angled toward the reservoirs 6. The vacuum pump 4 generates a negative pressure within the tubing system 1. The maple tubing system 1 may additionally comprise one or more system for controlling vacuum 10 configured to regulate the pressure in a conduit 8 associated to one or more sap producing trees 2. Broadly, the vacuum controller 10 comprises a valve 200 adapted to isolate the vacuum chamber of a vacuum pump 4 and thereby regulate the passage of a fluid within the tubing system 1 through a conduit, as well as a controller 300 adapted to operatively control the valve 200. The fluid within the tubing system 1 may be air, gas or a combination of a gas and a hydraulic fluid. In some embodiments, the hydraulic fluid may be a combination of the liquid, such as sap or milk, and air.

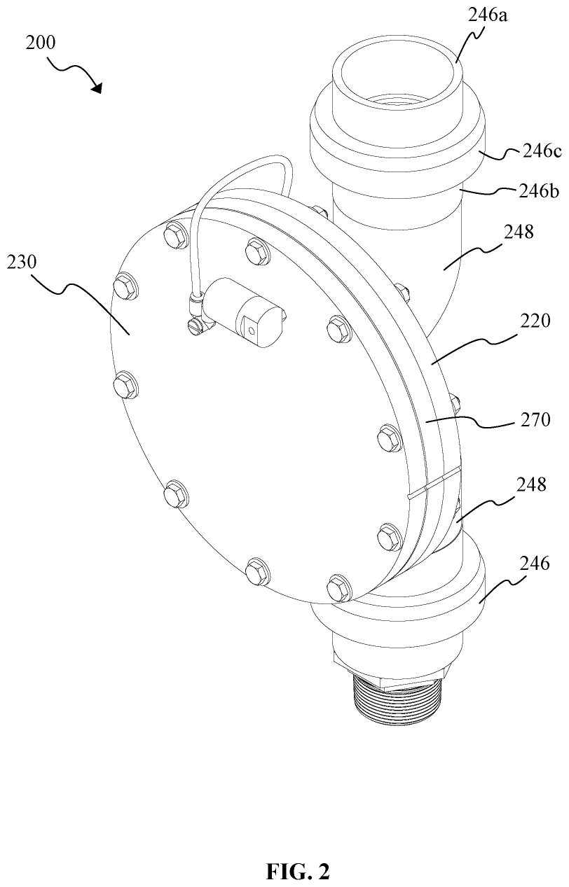

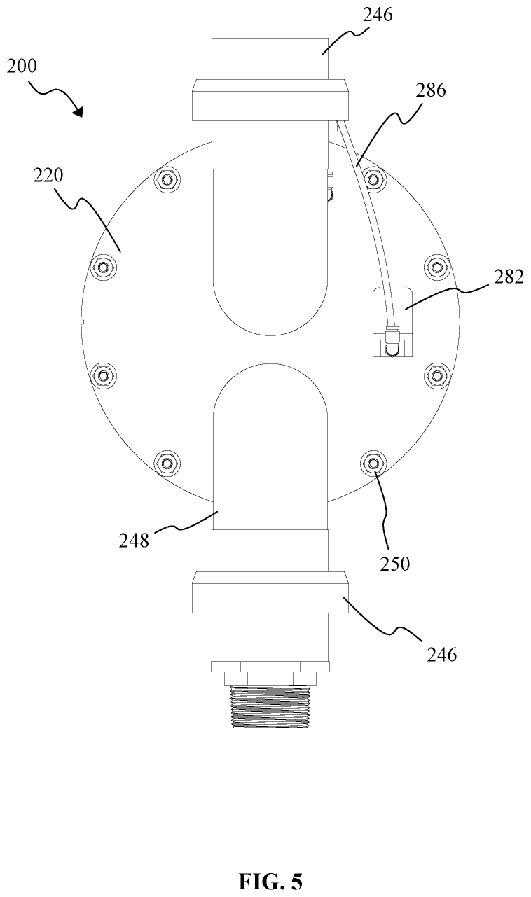

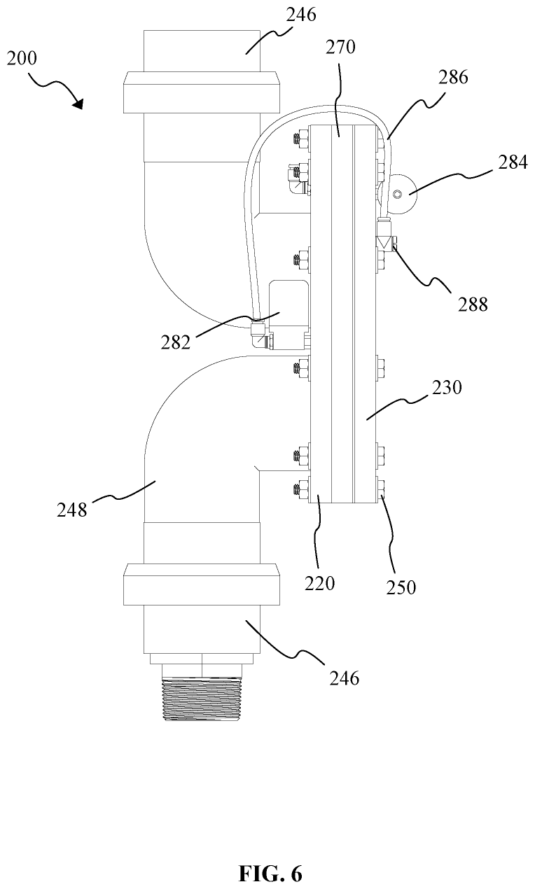

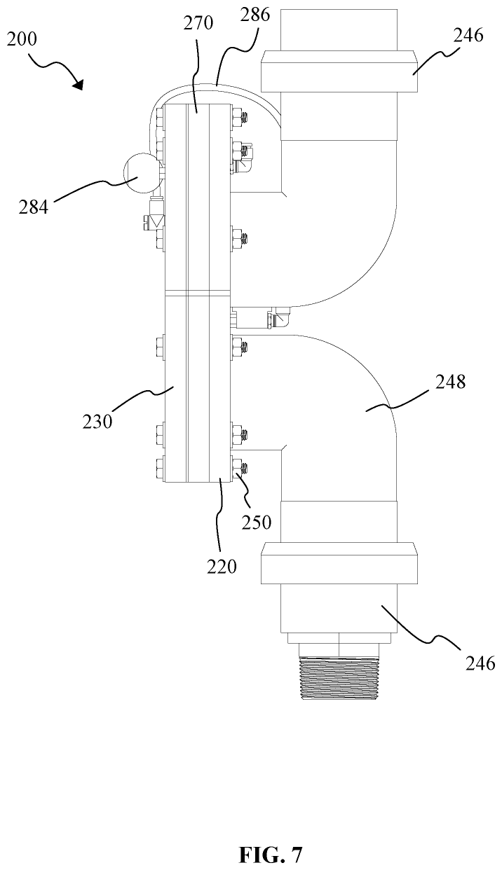

Referring to FIGS. 2 to 7, an embodiment of a vacuum valve 200 is illustrated. In some embodiments, the valve 200 may comprise a shell or body 220 forming a casing and primary pressure boundary of the valve 200 and a bonnet 230 forming a cover for the body 220. The body 220 and bonnet 230 may comprise, but not limited to, brass, bronze, gunmetal, cast iron, steel, alloy steel, stainless steel, PVC, PP, PVDF, glass-reinforced nylon or any other material suitable for conveying a negatively pressurized fluid, such as air, and being subjected to contain a depressurized environment. Understandably, the body 220 and bonnet 230 may form a unitary piece.

The body 220 typically comprises at least two ports 240 providing a passage for the fluid, such as air, in and out of the valve 200. In the embodiment illustrated in FIGS. 2 to 7, the valve 200 comprises two ports 240, namely an inlet 242 for fluidly receiving depressurized fluid from a conduit 8 and an outlet 244 for fluidly outputting the depressurized fluid into a conduit 8 fluidly connected to the pump 4, or in other embodiments to the reservoir 6. The ports 240 may comprise any cross-sectional area suitable for receiving the desired fluid flow rate passing through the valve 200. In the illustrated embodiment, the inlet 242 and the outlet 244 are rounded, typically sized to receive a tube, such as a PVC tube or pipe.

Referring again to FIG. 1, the inlet 242 is fluidly connected to a conduit 8 leading to the reservoir 6 or, in some embodiments, to the one or more fluid source 2, such as but not limited to sap producing trees or cow. The outlet 244 is fluidly connected to a conduit 8 in fluid communication with the pump 4, or in some embodiments with the reservoir 6 adapted to receive the conveyed fluid which include fluid from the source 2, such as sap. The inlet 242 and outlet are in vacuum controlled environment, typically fluidly connected to the vacuum pump 4. To that end, the depressurized fluid within the tubing system 1, such as air, may be conveyed from the one or more fluid source 2 or closed tubing system 1 into the valve 200 via the inlet 242 and out of the valve 200 via the outlet 244 towards the vacuum pump 4. In some embodiments, the fluid extracted from the fluid source 2 is received by the reservoir 6 in between the fluid source 2 and the valve 200.

In some embodiments, the valve 200 may be fluidly connected to the reservoir 6 and the reservoir 6 may be fluidly connected to the fluid source 2, such as trees or cows. In such embodiments, the fluid retrieved from the source 2 is isolated from the valve 200 which controls the vacuum level of the pressurize fluid within the closed system 1. In such embodiments, the valve may be connected to a plurality of reservoirs 6 which are connected to the different sources 2.

In yet another embodiment, the valve 200 may be fluidly connected to the source 2 of fluid and the reservoir 6 may be fluidly connected to the system 1. The reservoir 6 capturing the fluid conveyed from the source 2.

In another embodiment, the reservoir 6 may be connected between the vacuum pump 4 and the valve 200. In such an embodiment, the valve 200 controls the flow of source fluid and of depressurized fluid towards the reservoir 6 and/or the vacuum pump 4.

Understandably, the reservoir 6 may be embodied as a tank, container, releaser or extractor, such as a sap releaser, or as a combination thereof.

Referring again to FIGS. 2 to 7, the valve 200 may comprise one or more adapters 246 configured to form a sealed fluid connection between the conduits 8 and the ports 240. Accordingly, the adapters 246 may comprise a first end 246a having a cross-sectional shape suitable to receive a conduit 8 or to be inserted within a conduit 8 to form a sealed fluid connection. The adapters 246 may similarly comprise a second end 246b having a cross-sectional shape suitable to be inserted within a port 240 to form a sealed fluid connection. The adapters 246 may further comprise a ridge 246c extending radially therefrom configured to limit the longitudinal displacement of the adapter 246 when inserted into a conduit 8.

In other embodiments, the valve may comprise one or more fitting tubes 248 or connectors 249 disposed between one or more of the ports 240 and the adapters 246 in order to position the second end 246b of the adapters 246 in a more desirable position for receiving the conduits 8. In the embodiment illustrated in FIGS. 2 to 7, the valve 200 comprises two elbow-shaped fittings 248 adapted to fluidly connect the ports 240 to the adapters 246 while positioning the ports 240 to the adapters 246 at a 900 angle relative to one another and two straight connectors 249. Understandably, the fittings 248 and connectors 249 may have any other suitable shape.

The adapters 246 and fittings 248, 249 may be made of material suitable for conveying the fluid under a vacuum, such as but not limited to brass, bronze, gunmetal, cast iron, steel, alloy steels, stainless steels, PVC, PP, PVDF, or glass-reinforced nylon.

In certain embodiments, the mating between the surfaces of adjacent ports 240, adapters 246 or fittings 248 may be imperfect due to geometry incompatibility, improper tolerances or irregular deformations.

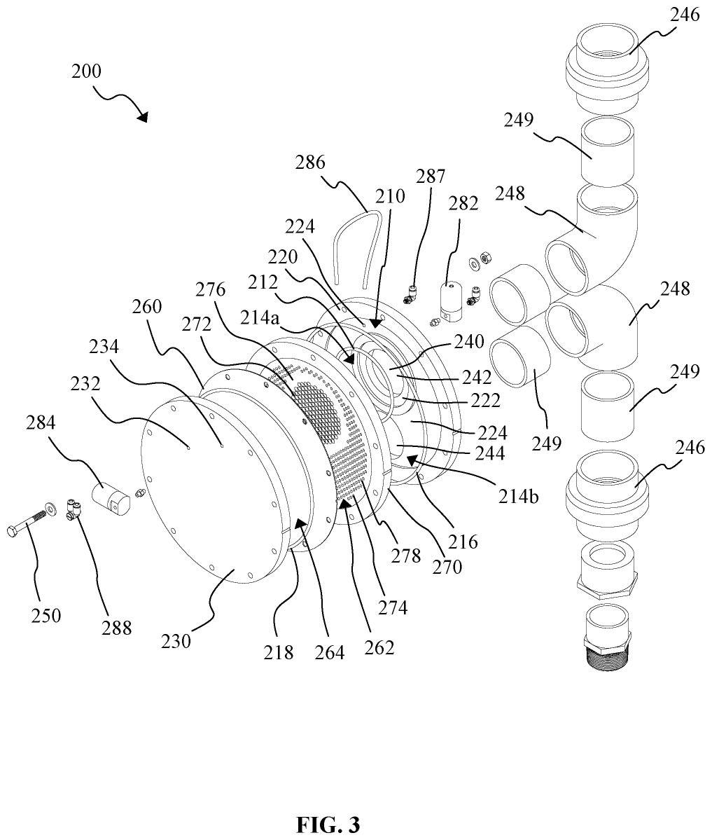

Still referring to FIG. 3, the valve 200 comprises a diaphragm or flexible membrane 260 for throttling or stopping the flow of the depressurized fluid through the valve 200. In particular, the diaphragm 260 is a pressure related component of the valve 200 displaceable between closed and open positions when subjected to pressure. Broadly speaking, in a closed position, the diaphragm 260 forms a closed partition between the inlet 242 and outlet 244 such as to stop the passage of the depressurized fluid throughout the valve 200. In an open position, the diaphragm 260 allow non-restricted passage of the sap throughout the valve 200. The diaphragm 260 may be made of any flexible yet sealing material, such as but no limited to elastomer such as, for example, rubber, TPE and PTFE.

In certain embodiments, the valve 200 may further comprise a variable passage between the inlet and the outlet 270. The passage 270 may comprise a seating surface 276 for holding diaphragm 260. In the illustrated embodiment, the seating surface 276 is an outer ring of the passage 270. Specifically, the seat 276 may provide a structural support for the diaphragm to allow the diaphragm 260 to move toward or away from the passage 270. When moving toward the passage, the diaphragm 260 forms a seal suitable for throttling or stopping the flow of sap through the valve 200. The passage 270 is preferably disposed between the ports 240 and the diaphragm 260. Still referring to FIG. 3, the diaphragm 260 may therefore be disposed between the bonnet 230 and the passage 270 thus defining a depressurized fluid cavity 262 (bound by the diaphragm 260 and the passage 270) as well as a dry cavity 264 (bound by the bonnet 230 and the diaphragm 260). The passage 270 further comprises a first aperture 272 in fluid communication with the inlet 242 and a second aperture 274 in fluid communication with the outlet 244. As embodied, the apertures 272 and 274 comprise a plurality of holes 278 creating variable aperture areas 272 and 274 as a function of the pressure within the dry cavity 264 and/or the depressurized fluid cavity 262. As an example, when the inner pressure in increased in the dry cavity 262 and/or the vacuum increased in the depressurized fluid cavity 264, the diaphragm 260 is pushed against the holes 278, thus reducing the overall permeable surface of the apertures 272 and 274. To the opposite, when the pressure within the depressurized fluid cavity is increased and/or the vacuum in the dry cavity 262 increased, the diaphragm 260 is pulled or pushed away from the passage 270, thus increase the permeable surface of the apertures 272 and 274.

In such an embodiment, the fluid pathline of the depressurized fluid within the valve 200 may commence at the inlet 242 and subsequently be directed across one or more inlet apertures 272 of the passage 270 into the depressurized fluid cavity 262. The depressurized fluid may subsequently be conveyed across one or more outlet apertures 274 of the passage 270 before being conveyed towards the outlet 244. Accordingly, the diaphragm 260 may prevent or limit the passage of the depressurized fluid through the valve 200 by being pushed against the passage 270. The diaphragm 260 may restrict depressurized fluid flow across either or both of the inlet apertures 272 and outlet apertures 274 as a function of the pressure or vacuum present in each dry 262 or depressurized fluid 264 cavities.

In certain embodiments, the valve 200 may further comprise gaskets 210 adapted to hydraulically seal the mating surfaces of two adjacent components of the valve 200. For example, in the embodiment illustrated in FIG. 3, the valve 200 comprises a gasket 212 configured to fluidly seal the body and the passage 270 around the inlet port 242. The gasket 212 thereby defines or creates a sealed partition between the two apertures 272 and 274. An inlet cavity 214a is formed between the inlet port 242 and the inlet apertures 272. An outlet cavity 214b is formed between the outlet port 244 and the outlet apertures 274.

The valve 200 may additionally comprise a gasket 216 adapted to fluidly seal the body 220 and the passage 270 near or adjacent to outer edges of both components. The valve 200 may further comprise a gasket 218 adapted to fluidly seal the bonnet 230 and the passage 270 near or adjacent to the outer edges of both components and thus sealing the dry cavity 264.

The gaskets 210, 216 or 218 may be made of any fluidly sealing material, such as but not limited to rubber, silicone, metal, cork, felt, neoprene, nitrile rubber, fiberglass, polytetrafluoroethylene, a plastic polymer or any other suitable material for hydraulically sealing the adjacent components.

As illustrated in FIG. 3, the passage 270 is embodied as disk having a first surface in communication ports 240 and a second surface in communication with the depressurized fluid cavity 264. The first surface comprises a partition between the outlet apertures 274 and inlet aperture 272. In such an embodiment, the body 220 comprise a recessed outlet portion 224 and a recessed inlet portion 222. The outlet portion 224 may surround the inlet portion 222. As described above, a gasket 212 may form a partition and ensure a seal between the inlet port 242 and an outlet cavity 214a formed between an outlet recessed portion formed in the first surface of the passage 270 and the outlet portion 224 of the body 220. The partition may further create an inlet cavity 214b between an inlet portion recessed portion formed in the first surface of the passage 270 and the inlet portion 222 of the body 220.

In certain embodiments, the valve 200 may further comprise one or more fasteners 250 configured to jointly secure one or more components of the valve 200. For example, and as illustrated in FIG. 3, the valve 200 comprises a plurality of fasteners 250 disposed along a periphery of the base 220 and the bonnet 230. The fasteners 250 hold together the base 220, the diaphragm 260 the passage 270 and the base 220 such as to jointly secure these four components. The fasteners 250 may comprise nuts and bolts, screws, clips, rivets, an adhesive or any other suitable fastening means.

During operation, the valve 200 may throttle or prevent the conveyance of depressurized fluid therethrough by selectively pushing the diaphragm 260 against the passage 270 or pulling the diaphragm from the passage 270. In certain embodiments, the position of the diaphragm 260 may be regulated by selectively adjusting the positive or negative pressure within the depressurized fluid cavity 262 and/or the dry cavity 264. When the vacuum pump 4 is in operation, a partial vacuum or negative pressure area may form within the outlet 244, the outlet cavity 244b and the depressurized fluid cavity 242 as such components are in fluid communication with one another via the outlet apertures 274. Understandably, when the pressure within the dry cavity 264 is greater than the pressure within the depressurized fluid cavity 262 or alternatively when the vacuum in the web cavity 262 is greater than the vacuum in the dry cavity 264, the pressure gradient across the surface of the diaphragm 260 may force a displacement of the diaphragm 260 towards the passage 270, typically pushed against the second surface of the passage 270. As such, to the diaphragm 260 partially or entirely fluidly block one or more of the outlet apertures 274. Referring once again to FIG. 3, the diaphragm 260 may further fluidly restrict the passage of the depressurized fluid across the inlet apertures 272 when resting on the seat 270 due to the geometry of the passage 220 and the positioning of the outlet apertures 274 relative to the inlet apertures 272.

In a preferred embodiment, the second surface of the passage 270 has a curved shape, allowing the diaphragm 260 to gradually be pushed against the said second surface as the vacuum within the depressurized fluid cavity 262 increases. As such, the center of the diagraph 260 is pushed against the second surface when a maximum vacuum is created in the depressurized fluid cavity, thus completely blocking the conveyance of depressurized fluid between the inlet 242 and outlet 244 ports.

In some embodiments, the valve 200 may further comprise a pressure balancing system 280 adapted to balance or vary the pressures within the depressurized fluid cavity 262 and/or the dry cavity 264. The balancing of pressure generally aims at opening or throttling of the valve 200. In particular, the pressure balancing system 280 may comprise a first servo valve 282 in fluid communication with both the depressurized fluid cavity 262 and the dry cavity 264. The first servo valve 282 is configured regulate the pressure/vacuum within the depressurized fluid cavity 262. The pressure balance module 280 may further comprise one or more pressure conduit 286 adapted to fluidly connect the depressurized fluid cavity 262 and the dry cavity 264. In a preferred embodiment, the conduit 286 is further in fluid communication with the first servo valve 282. Referring to FIGS. 2 to 7, the first servo valve 282 is fluidly connected to the base through an aperture 224 in the base 220. In the present example, the first servo valve 282 comprises two ports, one port being fluidly connected to the base 220 and the other port being fluidly connected to the conduit 286. The conduit 286 typically comprises a first end connected to the first servo valve 282 and a second end fluidly connected to an aperture 232 in the bonnet 230, the aperture 232 being in fluid communication with the dry cavity 264. To that end, the pressure balance module 280 may be configured to actuate the first servo valve 282 to create fluid passage between the depressurized fluid cavity 262 and the dry cavity 264. Understandably, when the first servo valve 282 is in an open configuration, a pressure balance may be achieved within the depressurized fluid cavity 262 and the dry cavity 264, thus reducing or increasing the pressure gradient across the surface of the diaphragm 260. In such instances, the diaphragm 260 may be released from the passage 270 and a passage of the depressurized fluid across the inlet apertures 272 and outlet apertures 274 may resume or the diaphragm 260 may be pushed against the passage 270 to reduce the flow of depressurized fluid between the inlet apertures 272 and the outlet apertures 274.

Understandably, the pressure balance module 280 may comprise any desirable number of servo valves 282 and pressure conduits 286 in any suitable configuration. For example, the first servo valve 282 may similarly be affixed to the bonnet 230 through a sealed passage in communication with the depressurized fluid cavity 262.

In certain embodiments, it may be desirable achieve a predetermined pressure gradient across the surface of the diaphragm 260 by varying the pressure or vacuum within the dry cavity 264. The valve 200 may therefore comprise a second servo valve 284 affixed to a second aperture 234 of the bonnet 230 similarly allowing a fluid communication between the ambient air and the dry cavity 264. The actuation of the second servo valve 284 into a closed configuration allows the pressure within the dry cavity to be maintained. When the second servo valve 284 is kept in a closed configuration, only the opening of the first servo valve 282 may vary the pressure within the dry cavity 264. As such when the first servo valve 282 is closed, the depressurized fluid cavity 262 and the dry cavity 264 become fluidly isolated. As such, if the second servo valve 284 is opened while the first servo valve 282 is closed, pressure within the dry cavity will increased, thus pushing the diaphragm 260 against the passage 270 to limit or block the flow of depressurized fluid between the inlet 242 and the outlet 244 of the valve 200. As such, the pressure within the dry cavity 264 is once again greater than the pressure within the depressurized fluid cavity 262 and the pressure gradient across the surface of the diaphragm 260 may displace it towards the passage 270 such as to fluidly block the inlet apertures 272 and/or outlet apertures 274.

To close the valve 200, the second servo valve 284 is closed to isolate the dry cavity 264 from the ambient air. While the second servo valve 284 is maintained closed, the first servo valve 282 is opened, thus creating a fluid connection between the depressurized fluid cavity 262 and the dry cavity 264. The depressurized fluid cavity 262 is negatively pressurized as the said depressurized fluid cavity 262 is in fluid communication with the vacuum pump 4. The pressure within the dry cavity 264 is decreased as a consequence of the fluid connection with depressurized fluid cavity 262. As the pressure with the dry cavity 264, the diaphragm 260 moves away from the passage 270 to let a flow of depressurized fluid through the apertures 272/274.

Understandably, the valve 200 may be partially opened or closed by controlling the level of pressure within the dry cavity 264. As an example, by opening the first servo valve 282 for a predetermined period of the time, the pressure within the dry cavity 264 will decrease but will not balance with the vacuum of the depressurized fluid cavity 262, thus partially releasing the diaphragm 260 from the passage 270. To the opposite, the second servo valve 284 may be momentarily opened to limit the increase of pressure within the dry cavity.

In certain embodiments, the first servo valve 282 and the second servo valve 284 may themselves be throttled or selectively actuated to achieve throttling of the pressure gradient across the surface of the diaphragm 260 whereby the diaphragm would rest against the seat 270 such as to block a portion, but not the entirety, of the inlet apertures 272 and/or outlet apertures 274. Obtaining a throttling pressure gradient may be desirable in order to restrict but not block the passage of sap through the valve 200.

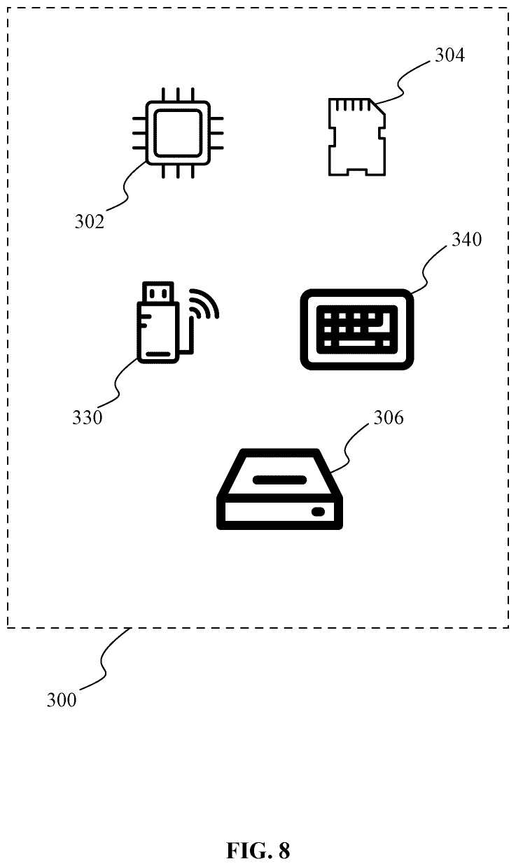

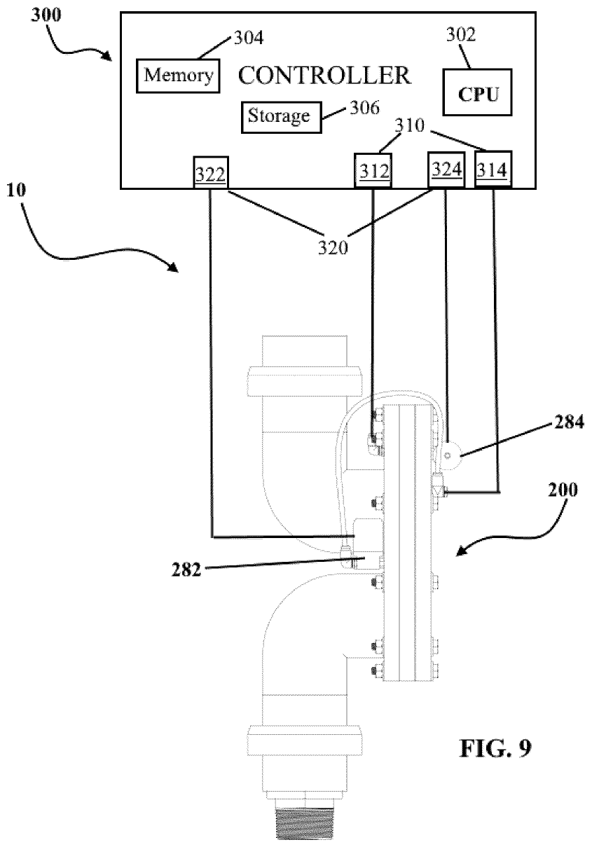

Referring now to FIGS. 8 and 9, the system for controlling vacuum 10 is illustrated. The system 10 may comprise a controller 300. The controller 300 typically triggers the actuation of the first servo valve 282 and of the second servo valve 284. In some embodiments, the controller 300 is embodied as a computing device having a central processing unit (CPU) 302, a memory unit 304, a storage unit 306, input/output ports 320, display unit 340 and a data communication unit 330. The controller 300 is typically powered by the electric distribution network or by a portable power source, such as a battery.

The storage unit is typically configured to store the information relative to the preferred pressure levels or opening/closing levels of the valve 200 as a function of other parameters, such as but not limited to time of the day, ambient and outside temperature, weather forecast, ambient pressure level, predetermined schedules, etc. Understandably, such parameters may be fetched from remote computers through a network in communication with the communication module.

The input/output 320 ports may comprise one or more data ports and/or any other know input/output ports. The data communication unit 330 may be embodied as wired or wireless communication module, such as, ethernet, WIFI, radio-frequency, mobile communication unit, etc. The first servo valve 282 and the ambient servo valve 284 may similarly comprise a data communication unit 330 embodied as a wired or wireless communication module, such as, ethernet, WIFI, mobile communication unit, etc. In such embodiment, the communication module of the servo valves 282, 284 is configured to receive request or messages from the controller 300 through a network.

The controller 300 may additionally comprise one or more sensors 310 configured to detect different parameters, such as pressure within the valve 200, temperature, atmospheric pressure, humidity level, wind speed, light intensity, etc. As explained above, the values retrieved from such sensors are used to modulate or control the operations of the valve 200. As such, the controller 300 is programmed or configured to calculate the required level of opening of the valve 200 or required pressure level in the dry cavity 264 to vary the vacuum in the piping conveying the depressurized fluid.

In some embodiment, the controller 300 comprises a first pressure 312 and a second pressure sensor 314. The first pressure sensor is in fluid communication with the depressurized fluid cavity 262 and the second pressure sensor is in fluid communication with the dry cavity 264. In the preferred embodiment, the first and second pressure sensors are connected to the depressurized fluid cavity 262 and dry cavity 264 respectively through a conduit. Understandably, in other embodiments, the pressure sensors, and other types of sensors, may be directly installed on the valve 200 and in communication with the controller 300.

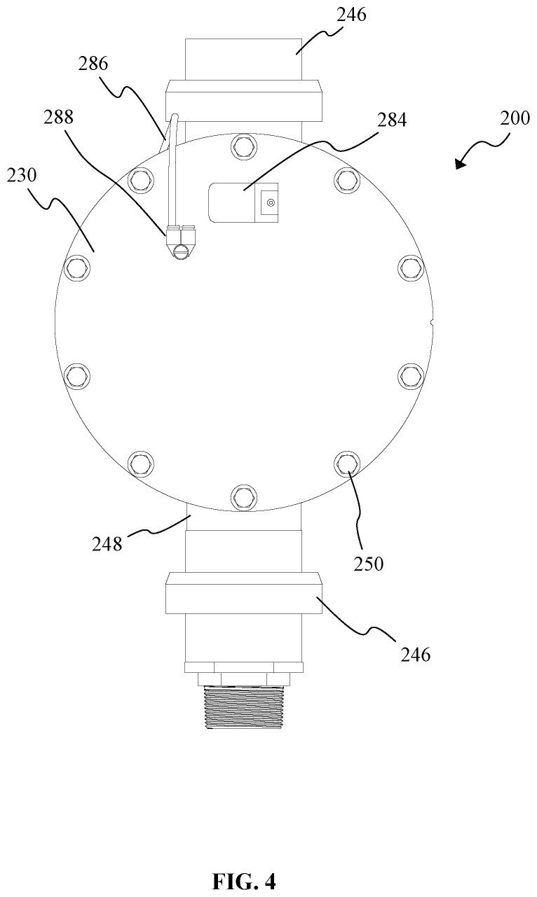

In the illustrated embodiment, a first conduit may be fluidly connected to the first sensor to an aperture 226 of the base 220, the aperture 226 being in fluid communication with the depressurized fluid cavity 262. A second conduit may fluidly connect the second sensor to another aperture 234 of the bonnet 230, the aperture 234 being in fluid communication with the dry cavity 264. As such, the controller 300 receives or fetch the pressure levels of the dry cavity 264 and of the depressurized fluid cavity 262. In some embodiments, the pressure levels are sent at a predetermined frequency or in real-time. In certain embodiments, the valve 200 may comprise conduit adapters 287, 288 affixed to the base 220 and/or to the bonnet 230, respectively and configured to receive the conduits to measure the pressure level with the cavities 262, 264. Referring to FIG. 4, the conduit adapter 288 may comprise two separate ports adapted to jointly receive the pressure conduit 286 and a measurement conduit.

In certain embodiments, the controller 300 may actuate the first servo valve 282 and the second servo valve 284 in accordance with a predetermined schedule or in response to a change of conditions or of measured parameters. For example, the controller 300 may actuate the first servo valve 282 and the second servo valve 284 such as to prevent depressurized fluid to flow through the valve 200 when the ambient temperature falls below a predetermined temperature or if the temperature is forecasted to fall below a predetermined temperature. The controller 300 may similarly actuate the first servo valve 282 and the second servo valve 284 such as to allow depressurized fluid to flow through the valve 200 when the ambient temperature reaches a predetermined temperature or, alternatively, if an upcoming thawing period is anticipated. In some embodiments, the controller 300 comprise I/O ports 322 and 324 powering and actuating the first 282 and second 284 servo valves.

It may be appreciated that the vacuum controller 10 may be utilized in tubing systems other than the maple tubing system 1 for the collection of sap such as milking tubing systems or any other tubing system for conveying a depressurized fluid with a vacuum pump.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A system for controlling vacuum level in a closed fluid system comprising:
a valve comprising:
an inlet fluidly connectable with the closed system;
an outlet in fluidly connectable to a vacuum pump;
a pressure-controlled vacuum control device between the inlet and the outlet;
a controller in fluid communication with the pressure-controlled vacuum control device, the controller being configured to:
measure the pressure in the valve;
vary the pressure in the pressure-controlled vacuum control device based on the measured pressure in the valve;
wherein a variation of pressure in the pressure-controlled vacuum control device impacts the vacuum level in the tubing system.

2) The system of claim 1, the pressure-controlled vacuum control device comprising a flexible membrane forming a first sealed cavity on a first side of the membrane and a second sealed cavity on a second side of the membrane, the second sealed cavity being in fluid communication with the closed system.

3) The system of claim 2, the controller being further configured to independently vary the pressure in the first sealed cavity and in the second sealed cavity.

4) The system of claim 3, the increase of pressure in the first sealed cavity reducing the vacuum level in the closed system and the decrease of pressure in the first sealed cavity increasing the vacuum level in the closed system.

5) The system of claim 2, the pressure-controlled vacuum control device further comprising a support for the flexible membrane, the support creating a passage between the inlet and the outlet, the opening of the passage being controlled by the flexible membrane.

6) The system of claim 5, the valve comprising a body and a bonnet, the support and the flexible membrane being between the body and the bonnet.

7) The system of claim 6 further comprising at least one fastener for securing the body, the flexible membrane, the support and the bonnet.

8) The system of claim 5, the support comprising at least one inlet aperture in fluid communication with the inlet and at least one outlet aperture in fluid communication with the outlet.

9) The system of claim 8, the flexible membrane fluidly restricting one of the at least one aperture when the pressure in the first sealed cavity is higher than the pressure in the second sealed cavity.

10) The system of claim 2, the valve further comprising pressure balancing system in fluid communication with the first sealed cavity and the second sealed cavity.

11) The system of claim 10, the pressure balancing module comprising a first servo valve controlling the variation of pressure level in the first sealed cavity through input of a fluid in the first sealed cavity, the inputted fluid having a pressure level higher than the vacuum level in the closed system.

12) The system of claim 11, the pressure balancing module further comprising a second servo valve balancing the pressure level between the first sealed cavity and the second sealed cavity.

13) The method of claim 12, the system further comprising first and second sensors in communication with the controller, the first sensor being configured to measure the pressure level in the first sealed cavity and the second sensor being configure to measure the pressure level in the second cavity, the controller being configured to control the first and second servo valve to vary the pressure level in the first and second sealed cavities based on the pressure level measured by the first and second sensors.

14) The system of claim 2, the flexible membrane being made with an elastomer.

15) The system of claim 1 comprising a pressure sensor measuring the pressure level in the valve.

16) The system of claim 15, the sensor being in communication with the controller.

17) The system of claim 15, the sensor being fluidly connected to the valve.

18) The system of claim 2, the system further comprising first and second sensors in communication with the controller, the first sensor being configured to measure the pressure level in the first sealed cavity and the second sensor being configure to measure the pressure level in the second cavity.

19) The system of claim 1, the closed fluid system comprising gas.

20) The system of claim 19, the gas being air.

21) The system of claim 1, the closed fluid system conveying sap from trees.

22) The system of claim 1, the closed fluid system conveying milk from animals.

23) A method for controlling vacuum level in a closed fluid system, the method comprising:
increasing the relative pressure in a first sealed cavity of a valve in relation to a second cavity to decrease the vacuum level of the closed system, the second sealed cavity being in fluid communication with the closed system;
decreasing the relative pressure in the first sealed cavity in relation to the second sealed cavity to increase the vacuum level of the closed system.

24) The method of claim 23, the increase of the relative pressure in the first sealed cavity comprising allowing a fluid in the first sealed cavity, the fluid having a pressure level higher than the pressure level in the closed system in the first sealed cavity.

25) The method of claim 24, the fluid being ambient air.

26) The method of claim 24, wherein allowing the fluid comprises actuating a servo motor fluidly connecting a source of the fluid and the first sealed cavity.

27) The method of claim 23, the decrease of the relative pressure in the first sealed cavity comprising balancing at least in part the pressure level between the first sealed cavity and the second sealed cavity.

28) The method of claim 27, the balancing of the pressure level comprising actuating a servo motor fluidly connecting the first and then second sealed cavities.

29) The method of claim 23, the method further comprising measuring the vacuum level in the first sealed cavity.

30) The method of claim 29, the method further comprising measuring the vacuum level in the second sealed cavity.

31) The method of claim 30, the method further comprising a controller triggering the increase or the decrease of relative pressure based on the measured vacuum level in the first and second sealed cavities.

32) The method of claim 23, the closed fluid system comprising gas.

33) The system of claim 32, the gas being air.

34) The method of claim 23, the closed fluid system conveying sap from trees.

35) The method of claim 23, the closed fluid system conveying milk from animals.
